(19) United States
(12) Patent Application Publication
(10) Pub. No.: US 2007/0097279 A1
(43) Pub. Date: May 3, 2007

(54) Liquid crystal display device

(76) Inventor: Norio Sugiura, Kanagawa (JP)

Correspondence Address: NIXON & VANDERHYE, PC, 901 NORTH GLEBE ROAD, 11TH FLOOR, ARLINGTON, VA, 22203, US

(21) Appl. No.: 11/438,697

(22) Filed: May 23, 2006

(30) Foreign Application Priority Data
May 24, 2005 (JP) 2005-150565

(51) Int. Cl. G02F 1/1343

(52) U.S. Cl. 349/38

(57) ABSTRACT

The invention relates to a liquid crystal display device for use in a display unit of electronic appliances, which can attain excellent display characteristics, the display device having a control capacitance electrode which is electrically connected to a source electrode of a thin film transistor; a storage capacitance electrode which is electrically connected to the control capacitance electrode; a pixel electrode provided with a direct coupling part which is electrically connected to the control capacitance electrode, and a capacitive coupling part which is disposed and faced to the control capacitance electrode through an insulating film as it is isolated from the direct coupling part; and a dummy capacitive coupling part which is formed in a space between the direct coupling part and the capacitive coupling part, disposed and faced to the storage capacitance electrode through the protective film, and improves alignment defect of liquid crystals on the capacitive coupling part.

### BACKGROUND OF THE INVENTION

1. Field of the Invention

The present invention relates to a liquid crystal display device for use in a display unit etc. of electronic appliances, particularly, preferably for use in a liquid crystal display device which defines the alignment of liquid crystals by polymerizing polymerization components such as monomers contained in liquid crystals.

2. Description of the Related Art

In recent years, a liquid crystal display device has been used for a monitor device etc. in a television receiver and a personal computer. In these purposes, a wide viewing angle is demanded in which a display screen can be seen from every direction. For a liquid crystal display device which can attain a wide viewing angle, an MVA (Multi-domain Vertical Alignment) mode liquid crystal display device is known. The MVA mode liquid crystal display device includes liquid crystals of negative dielectric anisotropy which are sealed between a pair of substrates, a vertical alignment layer which aligns the liquid crystal molecules almost vertically with respect to the substrate surface, and an alignment defining structure which defines the alignment orientation of liquid crystal molecules. For the alignment defining structure, a line protrusion and an open part (main slit) of an electrode are used. When voltage is applied, the liquid crystal molecules are tilted in the direction vertical to the direction in which the alignment defining structure is extended. The alignment defining structure is used to provide a plurality of areas in a single pixel, the area being different in the alignment orientation of the liquid crystal molecules, and thus a wide viewing angle can be obtained.

However, in the MVA mode liquid crystal display device, since the line protrusion and the main slit of relatively wide width are provided in the pixel area, the aperture ratio of a pixel is reduced more than that of a liquid crystal display device in TN mode etc. which has no alignment defining structure, and thus a problem arise that a high light transmittance cannot be attained.

In order to solve the problem, there is an MVA mode liquid crystal display device including a pixel electrode which has a line electrode in a cross shape which is extended in parallel with or vertical to a bus line, a plurality of stripe electrodes which is obliquely branched from the line electrode in a cross shape and extended in the four orthogonal direction, and micro slits formed between the adjacent stripe electrodes. The liquid crystal molecules when voltage is applied are tilted in the direction in parallel with the direction in which the micro slits are extended by an oblique electric field generated at the electrode edge part of the pixel electrode. In the MVA mode liquid crystal display device, since the line protrusion and the main slit of wide width are not provided in pixel area, the degradation of the aperture ratio is suppressed. However, since the alignment control by the stripe electrodes and the micro slits is smaller than the alignment control by the line protrusion and the main slit, problems arise that the response time of the liquid crystals is long and that alignment irregularities tend to occur because of a finger press etc.

Then, to the liquid crystal display device having the pixel configuration above, a polymer sustained alignment (PSA) technique is introduced in which polymerization components (monomers and oligomers) that can be polymerized by light or heat are mixed in liquid crystals, voltage is applied to polymerize the polymerization components in the state in which liquid crystal molecules are tilted, and thus the tilt orientation of the liquid crystal molecules is learnt (for example, see Patent Reference 1). In the liquid crystal display device using the PSA technique, since a polymer layer which learns the tilt orientation of the liquid crystal molecules is formed on the interface between the liquid crystals and the alignment layer, strong alignment control can be obtained. Therefore, such an MVA mode liquid crystal display device can be implemented that can have a short response time of the liquid crystals, can ensure that the liquid crystal molecules are tilted in the direction in parallel with the direction in which the micro slits are extended, and hardly has alignment irregularities even through a finger press etc.

In a vertical alignment liquid crystal display device in which liquid crystal molecules are aligned vertically with respect to a substrate as one in the MVA mode, the birefringence properties of the liquid crystals are mainly used for switching light. Generally, in the vertical alignment liquid crystal display device, since the phase difference caused by birefringence is different between the light traveling in the normal direction of the display screen and the light traveling in an oblique direction, the gray scale level brightness characteristic (γ characteristic) is shifted from a set value in all the gray scale levels in the oblique direction of the screen more or less. Therefore, since the transmittance characteristic (T-V characteristic) of the voltage applied to the liquid crystals is different between the normal direction and the oblique direction of the display screen, there is a phenomenon in which the T-V characteristic is distorted to make the color of the screen whitish when seen in the oblique direction even though the T-V characteristic in the normal direction of the screen is adjusted optimally. This phenomenon is called “washout”.

For a unit to improve washout, a liquid crystal display device using a so-called capacitive coupling HT method (half tone gray scale method) is proposed. FIG. 6 shows the pixel configuration of the liquid crystal display device using the capacitive coupling HT method. As shown in FIG. 6, in the liquid crystal display device using the capacitive coupling HT method, the pixel area is split into a subpixel A formed with a pixel electrode (direct coupling part) 16 which is electrically connected to a switching device (for example, a TFT (thin film transistor) 20), and a subpixel B formed with a pixel electrode (capacitive coupling part) 17 which is electrically insulated from the TFT 20 and forms capacitance between it and a control capacitance electrode 26 which has potential equal to a source electrode 22 of the TFT 20. In the liquid crystal display device using the capacitive coupling HT method, the direct coupling part and the capacitive coupling part are provided in the pixel electrode. Thus, the alignment orientation of liquid crystals can be split in the polar angle direction as well as in the azimuth angle direction, different γ characteristics are provided in a pixel to suppress a shift from the front side in the phase difference caused by birefringence in the oblique direction, and washout can be reduced.

However, in the liquid crystal display device using the capacitive coupling HT method having the pixel configuration shown in FIG. 6, an alignment failed area (liquid crystal domain) which has an alignment greatly different from a desired alignment occurs in the border area between the subpixel A formed with the pixel electrode 16 which is connected to the source electrode 22 of the TFT 20 through a contact hole 24 and the subpixel B formed with the pixel electrode 17 which is connected to the source electrode 22 with capacitance. Therefore, a problem arises that the brightness, the response speed and the washout in the liquid crystal display device are greatly deteriorated.

For a unit to improve the brightness, the response speed and the washout in the liquid crystal display device, a liquid crystal display device using a capacitive coupling HT method is proposed as shown in FIG. 7 in which a pixel area is split into a subpixel A formed with a pixel electrode (direct coupling part) 16 which is electrically connected to a switching device (for example, a TFT (thin film transistor) 20) and a subpixel B formed with a pixel electrode (capacitive coupling part) 17 which is electrically insulated from the TFT 20 and forms capacitance between it and a control capacitance electrode 26 which has potential equal to a source electrode 22 of the TFT 20, as the subpixels A and B sandwich a storage capacitance bus line 18 and a storage capacitance electrode 19.

FIG. 7 shows the pixel configuration of the liquid crystal display device using the capacitive coupling HT method in which the pixel area is split into the subpixel A and the subpixel B as the subpixels A and B sandwich the storage capacitance bus line 18 and the storage capacitance electrode 19. FIG. 8 shows a cross section sectioned at a line A-A shown in FIG. 7. As shown in FIGS. 7 and 8, each of the pixel areas of the liquid crystal display device is split into the subpixel A and the subpixel B as the subpixels A and B sandwich the storage capacitance bus line 18 and the storage capacitance electrode 19. The pixel electrode 16 formed in the subpixel A is electrically connected to the source electrode 22 of the TFT 20 through a contact hole 24 which is formed by opening a protective film (insulating film) 31 on the storage capacitance electrode 19.

The storage capacitance bus line 18 is formed on a glass substrate 10 of a TFT substrate 2. The storage capacitance electrode 19 is formed on the storage capacitance bus line 18 through an insulating film 30. The control capacitance electrode 26 is electrically connected to the storage capacitance electrode 19. The protective film (insulating film) 31 is formed on the storage capacitance electrode 19 and the control capacitance electrode 26 throughout the surface of the substrate. The contact hole 24 is formed by partially opening the protective film 31 on the storage capacitance electrode 19, and a rectangular electrode 16e is electrically connected through the contact hole 24. To the rectangular electrode 16e, a pixel electrode 16b is electrically connected which is a part of the pixel electrode formed in the subpixel A.

The pixel electrode 17 is formed in the subpixel B. A part of the pixel electrode 17 faces the control capacitance electrode 26 through the protective film 31, and forms capacitance between it and the control capacitance electrode 26 as the protective film 31 is the capacitor film.

In the liquid crystal display device using the capacitive coupling HT method in which the pixel area is split into the subpixel A and the subpixel B as the subpixels A and B sandwich the storage capacitance bus line 18 and the storage capacitance electrode 19, the liquid crystal domain is formed over the storage capacitance bus line 18 and the storage capacitance electrode 19. Since the storage capacitance bus line 18 and the storage capacitance electrode 19 are opaque electrodes, the area over the storage capacitance bus line 18 and the storage capacitance electrode 19 is not used for display. Since the liquid crystal domain is formed in the area over the storage capacitance bus line 18 and the storage capacitance electrode 19, the brightness, the response speed and the washout in the liquid crystal display device are improved.

In the liquid crystal display device using the capacitive coupling HT method, the voltage to be applied is smaller in the liquid crystals in the capacitive coupling part than in the liquid crystals in the direct coupling part. Therefore, as shown in FIG. 8, electric field energy of the direct coupling part is greater than the electric field energy of the capacitive coupling part (in the drawing, it is schematically illustrated by arrows). Thus, the liquid crystal domain formed in the border between the direct coupling part and the capacitive coupling part occurs in the area close to the capacitive coupling part side, and it can protrude over the area on the capacitive coupling part depending on the voltage to be applied. When the liquid crystal domain protrudes over the area on the capacitive coupling part, a problem arises that the liquid crystal domain formed on the area on the capacitive coupling part can greatly deteriorate the brightness, the response speed and the washout in the liquid crystal display device.

Patent Reference 1: JP-A-2003-149647

Patent Reference 2: JP-A-2004-279904

### SUMMARY OF THE INVENTION

An object of the invention is to provide a liquid crystal display device which can obtain excellent display quality.

The object is attained by a liquid crystal display device including: a pair of substrates which are disposed as they face each other; liquid crystals sealed between the pair of the substrates; a polymer layer in which polymerization components contained in the liquid crystals are polymerized by optical or thermal polymerization; a gate bus line which is formed on one of the substrates; a drain bus line which is formed and intersected with the gate bus line through an insulating film; a thin film transistor provided with a gate electrode which is electrically connected to the gate bus line, and a drain electrode which is electrically connected to the drain bus line; a control capacitance electrode which is electrically connected to a source electrode of the thin film transistor; a storage capacitance electrode which is electrically connected to the control capacitance electrode; a pixel electrode provided with a direct coupling part which is electrically connected to the control capacitance electrode, and a capacitive coupling part which is disposed and faced to the control capacitance electrode through an insulating film and is formed as it is isolated from the direct coupling part; and a dummy capacitive coupling part which is formed in a space between the direct coupling part and the capacitive coupling part, which is disposed and faced to the storage capacitance electrode through the insulating film, and which improves alignment defect of liquid crystals on the capacitive coupling part.

In the liquid crystal display device according to the invention, a storage capacitance bus line is formed in the space between the direct coupling part and the capacitive coupling part and is formed almost in parallel with the storage capacitance electrode and the gate bus line.

In the liquid crystal display device according to the invention, almost same voltage is applied to the capacitive coupling part and the dummy capacitive coupling part.

In the liquid crystal display device according to the invention, the storage capacitance electrode is also formed outside an area overlapping with the storage capacitance bus line when seen in a substrate surface normal direction.

In the liquid crystal display device according to the invention, the dummy capacitive coupling part is also formed outside an area overlapping with the storage capacitance electrode when seen in a substrate surface normal direction.

According to the invention, a liquid crystal display device can be attained which can obtain excellent display quality.

### BRIEF DESCRIPTION OF THE DRAWINGS

The teachings of the invention can be readily understood by considering the following detailed description in conjunction with the accompanying drawings, in which:

FIG. 1 is a diagram illustrating the schematic configuration of a liquid crystal display device according to an embodiment of the invention;

FIG. 2 is a diagram illustrating the pixel configuration of the liquid crystal display device according to an embodiment of the invention;

FIG. 3 is a cross section illustrating the configuration of the liquid crystal display device according to an embodiment of the invention;

FIG. 4 is a diagram illustrating the pixel configuration of the liquid crystal display device according to an embodiment of the invention;

FIG. 5 is a table illustrating the relationship between the applied voltage and the alignment property of the liquid crystal display device according to an embodiment of the invention;

FIG. 6 is a diagram illustrating the pixel configuration of a liquid crystal display device before;

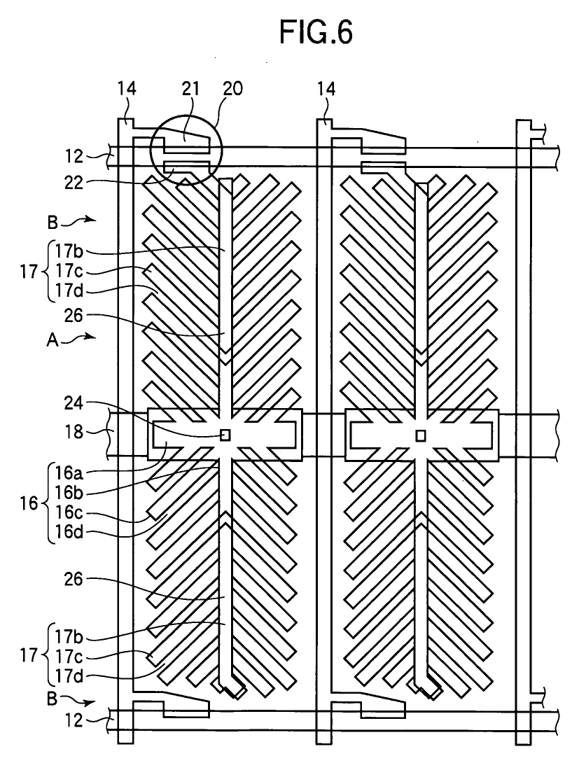

FIG. 7 is a diagram illustrating the pixel configuration of the liquid crystal display device before; and

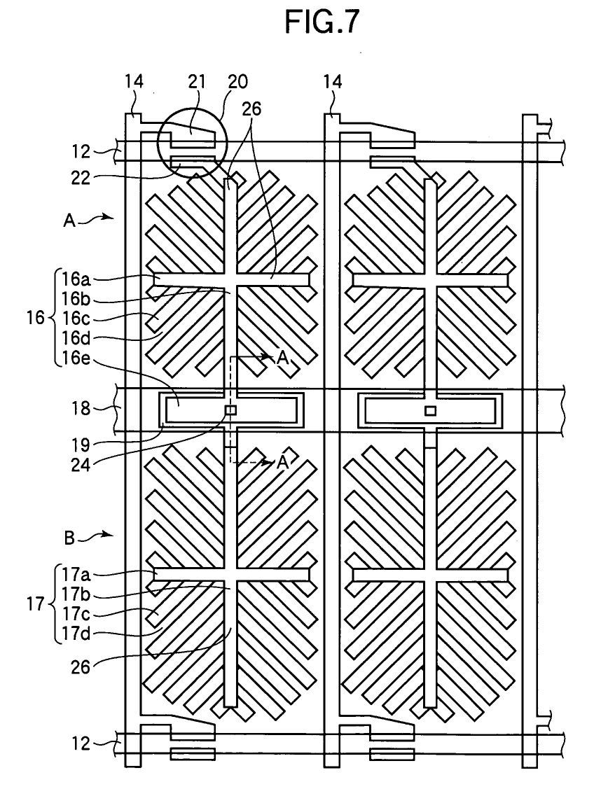

FIG. 8 is a cross section illustrating the configuration of the liquid crystal display device before.

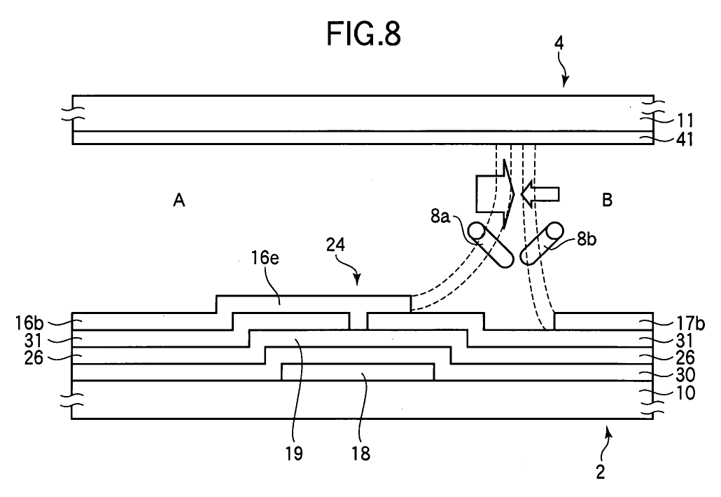

### DESCRIPTION OF THE PREFERRED EMBODIMENT

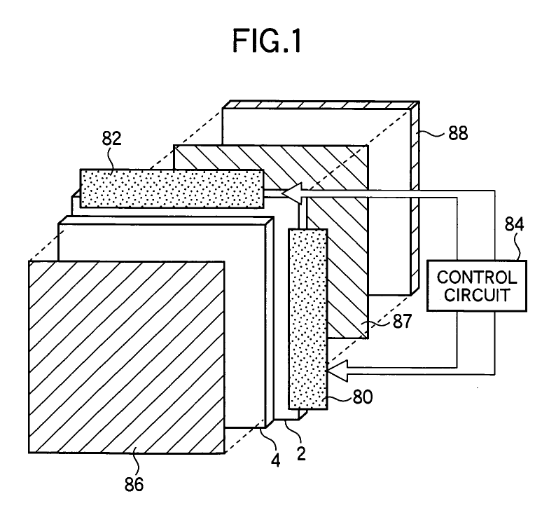

A liquid crystal display device according to an embodiment of the invention will be described with reference to FIGS. 1 to 5. FIG. 1 shows the schematic configuration of the liquid crystal display device according to the embodiment. As shown in FIG. 1, the liquid crystal display device has a TFT substrate 2 provided with gate bus lines and drain bus lines which are formed as they intersect with each other through an insulating film, and a thin film transistor (TFT) and a pixel electrode, which are formed at every pixel. In addition, the liquid crystal display device has a counter substrate 4 on which a color filter (CF) and a common electrode are formed, and which is disposed as it faces the TFT substrate 2. The substrates 2 and 4 are bonded to each other through a sealing material which is formed on the outer rim part on the faced surfaces. Between the substrates 2 and 4, vertical alignment liquid crystals of negative dielectric anisotropy are sealed to form a liquid crystal layer, not shown.

To the TFT substrate 2, drive circuits are connected: a gate bus line drive circuit 80 on which a driver IC is mounted to drive a plurality of the gate bus lines, and a drain bus line drive circuit 82 on which a driver IC is mounted to drive a plurality of the drain bus lines. These drive circuits 80 and 82 output a scanning signal and a data signal to a predetermined gate bus line or drain bus line based on a predetermined signal outputted from a control circuit 84. A polarizer 87 is formed on the surface of the TFT substrate 2 opposite to the surface on which TFT devices are formed, and a polarizer 86 is disposed in crossed Nicol with the polarizer 87 on the surface opposite to the surface of the counter substrate 4 on which the common electrode is formed. A backlight unit 88 is placed on the surface of the polarizer 87 opposite to the TFT substrate 2.

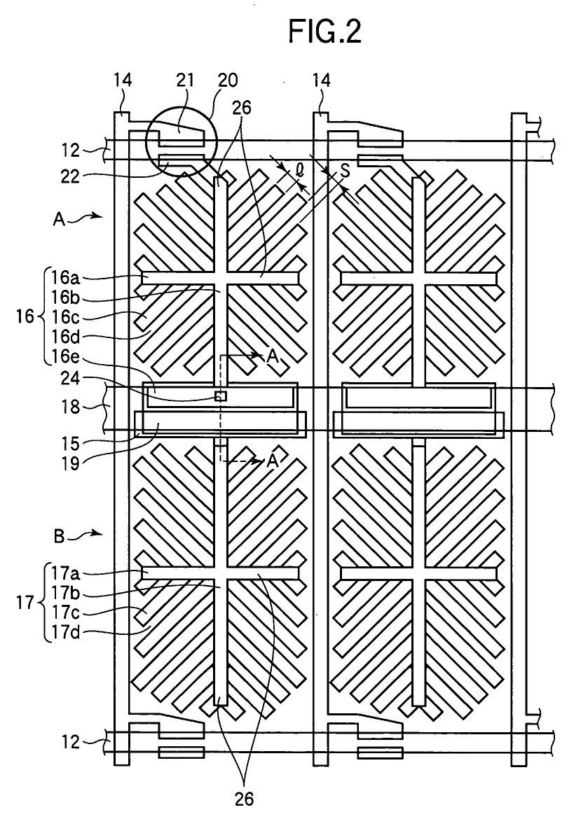

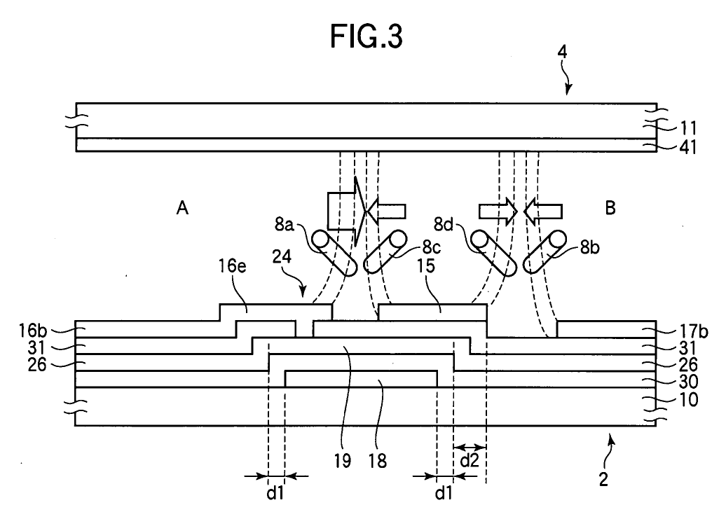

FIG. 2 shows the pixel configuration of the liquid crystal display device according to the embodiment, and FIG. 3 shows the sectional configuration of the liquid crystal display device sectioned at a line A-A shown in FIG. 2. As shown in FIGS. 2 and 3, the TFT substrate 2 of the liquid crystal display device has a plurality of gate bus lines 12 which is formed on a transparent insulating substrate (for example, a glass substrate) 10, and a plurality of drain bus lines 14 which is formed and intersected with the gate bus lines 12 through an insulating film 30. A storage capacitance bus line 18 is formed as crossing a pixel area surrounded by the gate bus lines 12 and the drain bus lines 14, which is extended in parallel with the gate bus lines 12. A TFT 20 is formed as a switching device which is disposed at every pixel near the position at which the gate bus line 12 and the drain bus line 14 intersect with each other. A drain electrode 21 of the TFT 20 is electrically connected to the drain bus line 14. In addition, a part of the gate bus line 12 functions as the gate electrode of the TFT 20. A protective film (insulating film) 31 is formed on the drain bus line 14 and the TFT 20 throughout the surface of the substrate. An alignment layer, not shown, is formed on the protective film 31 throughout the surface of the substrate, which almost vertically aligns liquid crystal molecules with respect to the substrate surface. A polymer layer, not shown, is formed in the interface between the alignment layer and the liquid crystal layer, which controls the alignment orientation of the liquid crystal molecules.

In the pixel area, a control capacitance electrode 26 is formed which is electrically connected to a source electrode 22 of the TFT 20 and extended in parallel with the drain bus line 14. In addition, on the storage capacitance bus line 18 in the pixel area, a storage capacitance electrode (intermediate electrode) 19 is formed through the insulating film 30, which forms storage capacitance (electrostatic capacitance) between it and the storage capacitance bus line 18 as the insulating film 30 is a capacitor film. As shown in FIG. 3, the storage capacitance electrode 19 is formed as it protrudes toward a subpixel A and a subpixel B by a predetermined width d1 more than the storage capacitance bus line 18 when seen in the substrate surface normal direction. More specifically, the storage capacitance electrode 19 is also formed outside the area overlapping with the storage capacitance bus line 18 when seen in the substrate surface normal direction. The control capacitance electrode 26 and the storage capacitance electrode 19 are formed in the same layer, and are electrically connected to each other.

Each of the pixel areas of the liquid crystal display device according to the embodiment has the subpixel A and the subpixel B which are disposed and faced to each other as they sandwich the storage capacitance bus line 18. The subpixel A is formed with a first pixel electrode (direct coupling part) 16, and the subpixel B is formed with a second pixel electrode (capacitive coupling part) 17 which is isolated from the pixel electrode 16 in the same layer, and which is formed of the same material as that of the first pixel electrode 16, for example.

The pixel electrode 16 formed in the subpixel A has a line electrode 16a which is extended almost in parallel with the gate bus line 12, and a line electrode 16b which is extended almost in parallel with the drain bus line 14. The line electrode 16a and the line electrode 16b are disposed and faced to the control capacitance electrode 26 through the protective film 31. In addition, the pixel electrode 16 has a plurality of line electrodes 16c which is obliquely branched from the line electrode 16a or 16b and extended in stripes in the four orthogonal direction in the subpixel A, and micro slits 16d which are formed between the adjacent line electrodes 16c. A width 1 of the line electrode 16c is 6 μm, for example, and a width s of the micro slit 16d is 3.5 μm, for example. The orientation in which the micro slits 16d are extended is 45°, 135°, 225° and 315° where the right direction (the direction in parallel with the line electrode 16a) is 0° in the drawing. In addition, the pixel electrode 16 has a rectangular electrode 16e which is disposed and faced to a part of the storage capacitance electrode 19 through the protective film 31. A contact hole 24 is formed on the storage capacitance electrode 19, and the pixel electrode 16 is electrically connected to the storage capacitance electrode 19, the control capacitance electrode 26 and the source electrode 22 through the contact hole 24.

The pixel electrode 17 formed on the subpixel B has a line electrode 17a which is extended almost in parallel with the gate bus line 12, and a line electrode 17b which is extended almost in parallel with the drain bus line 14. The line electrode 17a and the line electrode 17b are disposed and faced to the control capacitance electrode 26 through the protective film 31, and form capacitance between them and the control capacitance electrode 26 as the protective film 31 is the capacitor film. In addition, the pixel electrode 17 has a plurality of line electrodes 17c which is obliquely branched from the line electrode 17b and extended, and micro slits 17d which are formed between the adjacent line electrodes 17c. The widths of the line electrode 17c and the micro slit 17d are almost the same as the widths of the line electrode 16c and the micro slit 16d. The orientation in which the micro slits 17d are extended is 45°, 135°, 225° and 315° where the right direction (the direction in parallel with the line electrode 17a) is 0° in the drawing.

In the space between the rectangular electrode 16e and the pixel electrode 17, a dummy capacitive coupling part 15 is formed which is a rectangular electrode and isolated from the rectangular electrode 16e and the pixel electrode 17. The dummy capacitive coupling part 15 is formed in the same layer, and has the same material as that of the pixel electrode 16 and the pixel electrode 17. In addition, the dummy capacitive coupling part 15 is disposed and faced to a part of the storage capacitance electrode 19 and a part of the control capacitance electrode 26 through the protective film 31.

As shown in FIG. 3, the dummy capacitive coupling part 15 is formed and protruded on the subpixel B side by a predetermined width d2 more than the storage capacitance electrode 19 when seen in the substrate surface normal direction. More specifically, the dummy capacitive coupling part 15 is also formed outside the area overlapping with the storage capacitance electrode 19 when seen in the substrate surface normal direction. In addition, the width of the side of the dummy capacitive coupling part 15 which is in parallel in the direction in which the storage capacitance bus line 18 is extended (the lateral direction in the drawing) is greater than the width of the side of the storage capacitance electrode 19 which is in parallel in the direction in which the storage capacitance bus line 18 is extended. The dummy capacitive coupling part 15 forms capacitance between the storage capacitance electrode 19 and the control capacitance electrode 26 as the protective film 31 is the capacitor film. In addition, almost the same voltage is applied to the dummy capacitive coupling part 15 and the pixel electrode (capacitive coupling part) 17.

On the other hand, the counter substrate 4 has a CF resin layer, not shown, which is formed on a glass substrate 11. Each of the pixels is formed with a CF resin layer in the color of any one of red, green and blue. On the CF resin layer throughout the surface of the substrate, a common electrode 41 is formed which is formed of a transparent conductive film. On the common electrode 41 throughout the surface, an alignment layer, not shown, is formed which almost vertically aligns liquid crystal molecules 8 with respect to the substrate surface. In the interface between the alignment layer and the liquid crystal layer, a polymer layer, not shown is formed as similar to the polymer layer on the TFT substrate 2 side. For example, the polymer layer is formed by optically or thermally polymerizing polymerization components such as monomers contained in the liquid crystals in the state in which a predetermined voltage is applied to the liquid crystal layer. The alignment orientation of liquid crystals is defined by the polymer layer in the direction in which the micro slits are extended. When no voltage is applied, the liquid crystals are aligned almost vertically with respect to the substrate surface.

According to the liquid crystal display device of the embodiment, the dummy capacitive coupling part 15 is disposed in the space over the storage capacitance bus line 18 and the storage capacitance electrode 19 between the pixel electrode 16 being the direct coupling part and the pixel electrode 17 being the capacitive coupling part. Thus, the alignment failed area (liquid crystal domain) can be prevented from protruding over the capacitive coupling part (the subpixel B). Since electric field energy of the pixel electrode 16 being the direct coupling part is greater than the electric field energy of the dummy capacitive coupling part 15 (it is schematically illustrated by arrows in FIG. 3), the liquid crystal domain formed in the border between the pixel electrode 16 being the direct coupling part and the dummy capacitive coupling part 15 occurs in the area near the dummy capacitive coupling part 15 side, and the liquid crystal domain protrudes over the area on the dummy capacitive coupling part 15, depending on the voltage to be applied. However, the dummy capacitive coupling part 15 is formed over the storage capacitance bus line 18 and the storage capacitance electrode 19 of opaque electrodes, to which the light from the backlight is not transmitted resulting in no display. Thus, the deterioration of the brightness, the response speed and the washout in the liquid crystal display device caused by the liquid crystal domain can be suppressed.

In addition, the liquid crystal domain formed in the border between the pixel electrode 17 being the capacitive coupling part and the dummy capacitive coupling part 15 stably exists in the border between both of them because the electric field energy of the pixel electrode 17 and that of the dummy capacitive coupling part 15 are the same (it is schematically illustrated by arrows in the drawing). Therefore, the place to create the liquid crystal domain can be defined.

In order to polymerize monomers, it is necessary that voltage is applied to the liquid crystal layer. There are two methods of applying voltage to the liquid crystal layer: a method of applying voltage between the drain bus line 14 and the common electrode 41, and a method of applying voltage between the storage capacitance bus line 18 and the common electrode 41. Special design is not required in the method of applying voltage between the drain bus line 14 and the common electrode 41 since this method is the same method as a normal method of driving liquid crystals. On the other hand, it has a problem that in the vicinity of the drain bus line 14 the alignment of liquid crystals is disturbed near the drain bus line 14 by a leak electric field from the drain bus line 14 to fail to obtain a desired alignment of liquid crystals as well as the transmittance etc. is not better than that in the method of applying voltage between the storage capacitance bus line 18 and the common electrode 41.

On the other hand, the method of applying voltage between the storage capacitance bus line 18 and the common electrode 41 allows excellent liquid crystals alignment and display characteristics. However, when the method of applying voltage between the storage capacitance bus line 18 and the common electrode 41 is used, such design is required in a liquid crystal display panel that the storage capacitance electrode 19 protrudes over the subpixel A side and the subpixel B side more than the storage capacitance bus line 18 when seen in the substrate surface normal direction.

In the method of applying voltage between the storage capacitance bus line 18 and the common electrode 41, the voltage applied between the storage capacitance bus line 18 and the common electrode 41 in polymerizing monomers is divided in accordance with the capacitance ratio between the liquid crystal layer and the storage capacitance. Therefore, when the storage capacitance bus line 18 is formed to protrude over the subpixel A side and the subpixel B side more than the storage capacitance electrode 19 when seen in the substrate surface normal direction, the voltage applied to the storage capacitance is greater than the voltage applied to the liquid crystal layer on the direct coupling part and the capacitive coupling part in polymerizing monomers. Thus, the leak electric field from the storage capacitance bus line 18 to the liquid crystal layer greatly disturbs the alignment of liquid crystals. Consequently, such design is necessary in which the storage capacitance electrode 19 is formed to protrude over the subpixel A side and the subpixel B side more than the storage capacitance bus line 18 when seen in the substrate surface normal direction and the leak electric field from the storage capacitance bus line 18 is prevented. Similarly, the dummy capacitive coupling part 15 disposed over the storage capacitance electrode 19 is also formed outside the area overlapping with the storage capacitance electrode 19 when seen in the substrate surface normal direction. Thus, the leak electric field from the storage capacitance electrode 19 to the liquid crystal layer of the capacitive coupling part can be prevented in polymerizing monomers, and the polymer layer can be formed which can implement excellent liquid crystals alignment.

Hereinafter, the liquid crystal display device according to the embodiment will be described more in detail with an experimental example.

Experimental Example

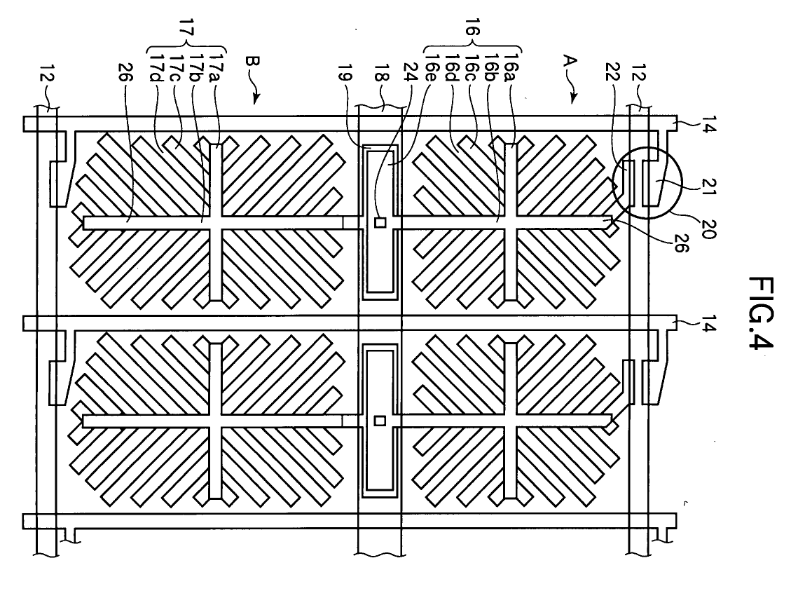

Six panels were prepared in total: three panels of the liquid crystal display panel using the capacitive coupling HT method in the pixel configuration according to the embodiment shown in FIG. 2, and three conventional panels of a liquid crystal display panel using the capacitive coupling HT method in the pixel configuration in which the dummy capacitive coupling part 15 was not disposed over the storage capacitance bus line 18 and the storage capacitance electrode 19 as shown in FIG. 4 for comparison. For the liquid crystals, liquid crystals of negative dielectric anisotropy containing monomers were used.

Eight types of AC voltage, 2 V, 2.5 V, 3 V, 5 V, 7.5 V, 10 V, 20 V and 30 V, were applied between the storage capacitance bus line 18 and the common electrode 41 for each of six liquid crystal display panels, and the properties of the alignment of liquid crystals with respect to the applied voltage were tested for the six liquid crystal display panels.

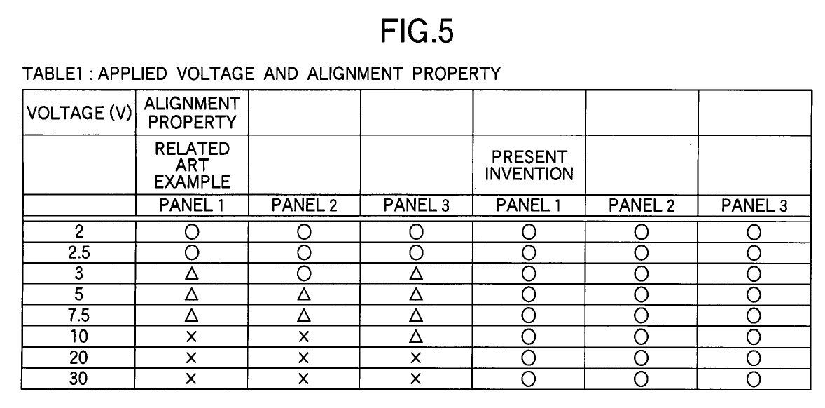

FIG. 5 is a table illustrating the relationship between the applied voltage and the alignment property in the individual liquid crystal display panels. In FIG. 5, a liquid crystal display panel that obtained excellent alignment properties is denoted by “a circle”, a liquid crystal display panel that obtained slightly less excellent alignment properties is denoted by “a triangle”, and a liquid crystal display panel that obtained not excellent alignment properties is denoted by “a cross”. As shown in FIG. 5, it is revealed that the conventional liquid crystal display panels (related art examples) obtain the alignment property worse and worse as the applied voltage is increased, whereas the liquid crystal display devices according to the embodiment (present invention) implement stable, uniform alignment even though the applied voltage is increased. The experiment above reveals that the dummy capacitive coupling part 15 is disposed in the space between the pixel electrode 16 being the direct coupling part and the pixel electrode 17 being the capacitive coupling part to implement excellent liquid crystals alignment.

The invention is not limited to the embodiment, which can be modified variously. For example, the transmissive liquid crystal display device is taken as an example and explained in the embodiment, but the invention is not limited thereto, which can also be adapted to other types of liquid crystal display devices such as a reflective type and a semi-transmissive type.

In addition, in the embodiment, the liquid crystal display device is taken as an example in which the CF resin layer is formed on the counter substrate 4, but the invention is not limited thereto, which can also be adapted to a liquid crystal display device of a so-called CF-on-TFT structure in which a CF resin layer is formed on a TFT substrate 2.

What is claimed is:

1. A liquid crystal display device comprising:
a pair of substrates which are disposed as they face each other;
liquid crystals sealed between the pair of the substrates;
a polymer layer in which polymerization components contained in the liquid crystals are polymerized by optical or thermal polymerization;
a gate bus line which is formed on one of the substrates;
a drain bus line which is formed and intersected with the gate bus line through an insulating film;
a thin film transistor provided with a gate electrode which is electrically connected to the gate bus line, and a drain electrode which is electrically connected to the drain bus line;
a control capacitance electrode which is electrically connected to a source electrode of the thin film transistor;
a storage capacitance electrode which is electrically connected to the control capacitance electrode;
a pixel electrode provided with a direct coupling part which is electrically connected to the control capacitance electrode, and a capacitive coupling part which is disposed and faced to the control capacitance electrode through an insulating film and is formed as it is isolated from the direct coupling part; and
a dummy capacitive coupling part which is formed in a space between the direct coupling part and the capacitive coupling part, which is disposed and faced to the storage capacitance electrode through the insulating film, and which improves alignment defect of liquid crystals on the capacitive coupling part.

2. The liquid crystal display device according to claim 1, wherein a storage capacitance bus line is formed in the space between the direct coupling part and the capacitive coupling part and is formed almost in parallel with the storage capacitance electrode and the gate bus line.

3. The liquid crystal display device according to claim 1, wherein almost same voltage is applied to the capacitive coupling part and the dummy capacitive coupling part.

4. The liquid crystal display device according to claim 1, wherein the storage capacitance electrode is also formed outside an area overlapping with the storage capacitance bus line when seen in a substrate surface normal direction.

5. The liquid crystal display device according to claim 1, wherein the dummy capacitive coupling part is also formed outside an area overlapping with the storage capacitance electrode when seen in a substrate surface normal direction.
